(19) United States
(12) Patent Application Publication
(10) Pub. No.: US 2014/0370330 A1
(43) Pub. Date: Dec. 18, 2014

(54) HOT-DIP PLATED HIGH-STRENGTH STEEL SHEET FOR PRESSWORK EXCELLENT IN LOW-TEMPERATURE TOUGHNESS AND CORROSION RESISTANCE AND MANUFACTURING METHOD THEREOF

(71) Applicant: NIPPON STEEL & SUMITOMO METAL CORPORATION, Tokyo (JP)

(72) Inventor: Hironori Sato, Tokyo (JP)

(21) Appl. No.: 14/368,229

(22) PCT Filed: Dec. 18, 2012
(86) PCT No.: PCT/JP2012/082845

§ 371 Date: Jun. 23, 2014

(30) Foreign Application Priority Data
Dec. 27, 2011 (JP) 2011-286376

(51) Int. Cl. C23C 2/02; C23C 2/06; B32B 15/01; C21D 8/02

(52) U.S. Cl. CPC C23C 2/02; C21D 8/0263; C21D 8/0236; C23C 2/06; B32B 15/013; C22C 38/58
USPC 428/659; 148/522

(57) ABSTRACT

A hot-dip plated high-strength steel sheet for presswork having a tensile strength of 340 MPa or more and less than 540 MPa, a press formability capable of being applied to a fuel tank, excellent secondary work brittleness resistance and low-temperature toughness of a seam weld zone, and excellent corrosion resistance, is provided. It is characterized in that, in a high-strength steel sheet having a hot-dip plated layer on a surface of a cold-rolled steel sheet, the cold-rolled steel sheet contains, by mass %, C: 0.0005 to 0.0050%, Si: 0.30% or less, Mn: 0.70 to 3.00%, P: 0.05% or less, Ti: 0.01 to 0.05%, Nb: 0.01 to 0.04%, B: 0.0005 to 0.0030%, S: 0.01% or less, Al: 0.01 to 0.30%, N: 0.0005 to 0.010%, and a balance composed of Fe and inevitable impurities, and when the Ti content (%) is set to [Ti], the B content (%) is set to [B], and the P content (%) is set to [P], TB* defined by the following expression <A> is 0.03 to 0.06, and [B] and [P] satisfy the following expression <B>.

TB*=(0.11−[Ti])/(ln([B]×10000)) <A>

[P]≦10×[B]+0.03 <B>

### TECHNICAL FIELD

The present invention relates to a hot-dip plated high-strength steel sheet for presswork applied to fields of automobiles, home electric appliances and the like and a manufacturing method thereof, and particularly relates to a hot-dip plated high-strength steel sheet for presswork excellent in low-temperature toughness and corrosion resistance and suitable for a fuel tank of an automobile and a manufacturing method thereof.

### BACKGROUND ART

In recent years, for the purpose of improving fuel economy by reducing a weight of vehicle body, a strength of a steel sheet for automobile has been increased. Similarly, also in a steel sheet for fuel tank, because of a reduction in weight of a tank, a complication of design of a vehicle body, and further, in terms of a place where the fuel tank is housed and installed, a shape of the fuel tank becomes complicated, and accordingly, the steel sheet for fuel tank has been required to have excellent formability and high strength.

In order to satisfy the requirements of realizing both of the excellent formability and the high strength, there has been developed a high-strength IF steel being an IF (Interstitial Free) steel made by adding carbonitride forming elements such as Ti and Nb to an ultralow carbon steel, to which solid-solution strengthening elements such as P, Si, Mn and the like are further added.

However, when a conventional high-strength steel sheet is used in a fuel tank, there is a problem that a tensile strength of a coach peel seam weld zone at low temperature is low. Specifically, there is a problem that even if a strength of steel sheet is increased, a strength of welded joint is not increased in accordance with the high-strengthening of the steel sheet.

A fuel tank is manufactured by performing seam welding on two upper and lower cup-shaped parts at flange portions, in which a seam weld zone of the fuel tank has a coach peel shape (which indicates a shape of mutually welded flanges welded in such a manner that palms are folded to pray, and is described as “coach peel seam weld zone” or “coach peel weld zone”, hereinafter), as shown in FIG. 6, and in particular, when a high-strength steel sheet is used, a stress is easily concentrated on a weld zone, compared to a normal cold-rolled steel sheet, and as a result of this, there is a tendency that a toughness is lowered and a tensile strength is lowered.

Further, the IF steel fixes C, N and the like as a carbide or a nitride of Nb or Ti, so that a crystal grain boundary becomes very clean, and after forming, a secondary work low-temperature embrittlement easily occurs due to a grain boundary fracture, which is a problem. Particularly, when a high-strength IF steel is used, an inside of grain is strengthened by a solid-solution strengthening element, and a lowering of relative grain boundary strength becomes obvious, and the secondary work low-temperature embrittlement is facilitated, which is a problem.

These become concerns regarding a fracture resistance of a fuel tank being an important safety related part when the fuel tank receives impact due to collision particularly in a low-temperature region.

Further, it has been conventionally proposed to use various types of alloy plated steel sheets formed by performing Pb—Sn alloy plating, Al—Si alloy plating, Sn—Zn alloy plating, or Zn—Al alloy plating on surfaces of steel sheets, in which the steel sheets are required to have good plating properties when being coated with the above alloy plating through hot-dipping.

Regarding these problems, some methods for avoiding the occurrence of secondary work embrittlement have been proposed (refer to Patent Documents 1 and 2, for example). In Patent Document 1, there is proposed a technique in which in a Ti-added IF steel, an amount of P is reduced as much as possible and large amounts of Mn and Si are added by the amount of reduced P, to obtain a high-tensile steel sheet excellent in secondary work brittleness resistance, in order to avoid the secondary work embrittlement caused by grain boundary segregation.

In Patent Document 2, there is proposed a technique in which not only Ti and Nb but also B is added to an ultralow carbon steel sheet to increase a grain boundary strength and to enhance the secondary work brittleness resistance. In the technique described in Patent Document 2, an amount of B is optimized for the purpose of improving the secondary work brittleness resistance and preventing an increase in load during hot rolling in accordance with a delay of recrystallization of austenite grains.

Further, some propositions have been made for the purpose of improving a weldability (refer to Patent Documents 3 to 5 and Non-Patent Document 1, for example).

A technique described in Patent Document 3 is a technique in which an ultralow carbon steel sheet to which Ti and/or Nb are (is) added is carburized during annealing, and structures of martensite and bainite are formed on a surface layer, to thereby improve a spot weldability. A technique described in Patent Document 4 is a technique in which Cu is added to an ultralow carbon steel to enlarge a heat-affected zone during welding, thereby increasing a strength of a spot-welded joint.

A technique described in Patent Document 5 is a technique in which a grain refining of structures of a weld zone and a heat-affected zone is performed by utilizing a pinning effect of Mg oxide and/or Mg sulfide to prevent a deterioration of fatigue strength. Non-Patent Document 1 discloses a technique in which TiN is finely dispersed in a thick steel sheet to improve a toughness of a weld zone and a heat-affected zone.

Further, some techniques of improving a hot-dip platability of a high-strength steel sheet have been proposed (refer to Patent Documents 6 and 7, for example).

In a hot-dip galvanized high-strength cold-rolled steel sheet described in Patent Document 6, a content of S which hinders a hot-dip platability is limited to 0.03 mass % or less, and a content of P is limited to 0.01 to 0.12 mass %, and Mn and Cr are added as strengthening elements. In a high-tensile alloyed galvanized steel sheet described in Patent Document 7, a mutual relationship between Si and Mn is defined to improve a hot-dip alloy Zn platability.

There has been disclosed a steel sheet excellent in strength and secondary work brittleness resistance in which B is added and a balance of addition of Mn and P is optimized to improve the secondary work brittleness resistance (refer to Patent Document 8, for example). Further, there has also been disclosed a technique of adding B, Ti, and Nb for improving the secondary work brittleness resistance (refer to Patent Document 9, for example).

Further, a technique of improving a tensile strength of a coach peel weld zone peculiar to a fuel tank (refer to Patent Document 10, for example), and a technique related to a high-strength steel sheet for deep drawing or presswork (refer to Patent Documents 11 to 15, for example) have been disclosed.

### PRIOR ART DOCUMENT

### Patent Document

Patent Document 1: Japanese Laid-open Patent Publication No. H5-59491
Patent Document 2: Japanese Laid-open Patent Publication No. 116-57373
Patent Document 3: Japanese Laid-open Patent Publication No. H7-188777
Patent Document 4: Japanese Laid-open Patent Publication No. H8-291364
Patent Document 5: Japanese Laid-open Patent Publication No. 2001-288534
Patent Document 6: Japanese Laid-open Patent Publication No. 115-255807
Patent Document 7: Japanese Laid-open Patent Publication No. H7-278745
Patent Document 8: Japanese Laid-open Patent Publication No. 2000-192188
Patent Document 9: Japanese Laid-open Patent Publication No. 116-256900
Patent Document 10: Japanese Laid-open Patent Publication No. 2007-119808
Patent Document 11: Japanese Laid-open Patent Publication No. 2007-169739
Patent Document 12: Japanese Laid-open Patent Publication No. 2007-169738
Patent Document 13: Japanese Laid-open Patent Publication No. 2007-277713
Patent Document 14: Japanese Laid-open Patent Publication No. 2007-277714
Patent Document 15: Japanese Unexamined Patent Application Publication No. 2008-126945

### Non-Patent Document

Non-Patent Document 1: Iron and Steel, Vol. 65 (1979), No. 8, page 1232

### SUMMARY OF THE INVENTION

### Problems to Be Solved by the Invention

However, the above-described conventional techniques have the following problems. The steel sheets manufactured through the methods described in Patent Documents 1 and 2 have problems such that although the workability is good, when press forming is conducted under severe conditions such as working conditions of a complicated fuel tank shape in particular, the secondary work brittleness resistance is insufficient, and further, the strength of the coach peel weld zone of the welded joint is low.

The method of performing carburization during annealing described in Patent Document 3 has a problem that it is difficult to stably manufacture the steel sheet because, in an actual manufacturing facility, a sheet passage speed, an atmosphere gas composition, and a temperature are not constant, and a carburization amount is changed.

The method described in Patent Document 4 has a problem that a surface defect occurs due to the addition of Cu, and a yield is lowered. The methods described in Patent Document 5 and Non-Patent Document 1 have a problem that, although there is an effect in an are welding and the like in which a cooling rate after welding is relatively slow, there is no effect in a seam welding and the like in which the cooling rate is fast.

Further, the thick steel sheet described in Patent Document 5 and Non-Patent Document 1 has components different from those of a thin steel sheet for fuel tank, and further, it has a different shape of weld zone, so that it cannot be immediately applied to the fuel tank. The steel sheets described in Patent Documents 6 and 7 have a problem that although the hot-dip galvanizing property is good, the weldability and the secondary work brittleness resistance are insufficient.

The steel sheet described in Patent Document 8 has a disadvantageous point that the sufficient low-temperature toughness is not achieved since a large amount of P is contained for securing the strength, and the balance of P and B is not optimum from a point of view of the low-temperature toughness.

The technique described in Patent Document 9 has a problem that the sufficient strength and toughness of the weld zone cannot be secured since a large amount of Ti is used from a point of view of the improvement of formability, and further, the sufficient workability cannot be secured since the amount of Nb is small, even with the appropriate amount of addition of Ti.

The technique using the laser welding described in Patent Document 10 is difficult to be applied to the seam welding of the fuel tank. Further, Patent Document 10 discloses no technique of improving properties of weld zone by improving properties of base material. The techniques of improving the properties of base material described in Patent Documents 11 and 12 have problems that the corrosion resistance and the workability of the base material are low, and in addition to that, the toughness of the coach peel seam weld zone is low depending on the welding conditions.

The techniques described in Patent Documents 13 and 14 have a problem that the toughness of the coach peel seam weld zone is low depending on the welding conditions. Further, the technique described in Patent Document 13 also has a problem that the lowering of workability is caused.

The technique described in Patent Document 15 has a problem that a scale layer tends to be solidly generated on a surface of the steel sheet due to a large Si amount contained in the steel sheet, and in order to remove the scale layer, it is often the case that conditions of degreasing and pickling treatment have to be strictly controlled or a surface grinding treatment has to be performed by a brush for heavy duty grinding, and thus it is difficult to stably manufacture a hot-dip plated steel sheet having excellent corrosion resistance under usual degreasing and pickling conditions.

As described above, the conventional findings include a finding of increasing the secondary work brittleness resistance, and a finding of improving the toughness of weld zone in a field of thick steel sheets. However, since manufacturing steps of a fuel tank include a working step (pressing, for example), and a heat-affect step (seam welding, for example), so that not only the properties of base material, but also the properties after the working and the properties after the heat-affect are also important.

Specifically, when a high-strength steel sheet is used for a fuel tank, since the toughness is generally lowered, the secondary work brittleness resistance and the toughness of weld zone become important properties, and further, since the plating is performed on the surface of the steel sheet, the platability and the corrosion resistance also become important properties.

However, there is no technique, in the conventional techniques, that provides a high-strength steel sheet excellent in press formability, in which all of excellent secondary work brittleness resistance and toughness of coach peel seam weld zone at low temperature, and excellent platability and corrosion resistance are improved.

The present invention is made in view of such problems, and an object thereof is to provide a hot-dip plated high-strength steel sheet for presswork having a tensile strength of 340 MPa or more and less than 540 MPa, a press formability capable of being applied to a field of automobile, particularly a fuel tank, excellent secondary work brittleness resistance and excellent toughness of coach peel weld zone at low temperature, and excellent corrosion resistance, and a manufacturing method thereof.

### Means for Solving the Problems

The present invention is made, for solving the above-described problems, based on a result of studies regarding an influence of Ti, B, P and Al on a toughness of coach peel seam weld zone peculiar to a fuel tank and a secondary work brittleness resistance, and an influence of Si on a corrosion resistance, and a gist thereof is as follows.

(1)

A hot-dip plated high-strength steel sheet for presswork excellent in low-temperature toughness and corrosion resistance is characterized in that it includes a high-strength steel sheet having a hot-dip plated layer on a surface of a cold-rolled steel sheet, in which the above-described cold-rolled steel sheet contains, by mass %, C: 0.0005 to 0.0050%, Si: 0.30% or less, Mn: 0.70 to 3.00%, P: 0.05% or less, Ti: 0.01 to 0.05%, Nb: 0.01 to 0.04%, B: 0.0005 to 0.0030%, S: 0.01% or less, Al: 0.01 to 0.30%, N: 0.0005 to 0.010%, and a balance composed of Fe and inevitable impurities, when the Ti content (%) is set to [Ti], the B content (%) is set to [B], and the P content (%) is set to [P], TB* defined by the following expression <A> is 0.03 to 0.06, and [B] and [P] satisfy the following expression <B>.

TB*=(0.11−[Ti])/(ln([B]×10000)) <A>

[P]≦10×[B]+0.03 <B>

(2)

The hot-dip plated high-strength steel sheet for presswork excellent in low-temperature toughness and corrosion resistance according to the above-described (1), is characterized in that the above-described cold-rolled steel sheet further contains, by mass %, one or two or more of Cu: 0.005 to 1%, Ni: 0.005 to 1%, Cr: 0.005 to 1%, and Mo: 0.0005 to 1%.

(3)

The hot-dip plated high-strength steel sheet for presswork excellent in low-temperature toughness and corrosion resistance according to the above-described (1) or (2), is characterized in that the above-described hot-dip plated layer is made of Zn of 1.0 to 8.8 mass %, and a balance composed of Sn and inevitable impurities, and a plating deposition amount is 10 to 150 g/m² per one side.

(4)

The hot-dip plated high-strength steel sheet for presswork excellent in low-temperature toughness and corrosion resistance according to any one of the above-described (1) to (3), is characterized in that a secondary work brittleness resistance temperature after performing working on the above-described high-strength steel sheet at a drawing ratio of 1.9 is −50° C. or less.

(5)

The hot-dip plated high-strength steel sheet for presswork excellent in low-temperature toughness and corrosion resistance according to any one of the above-described (1) to (4), is characterized in that a ductile-brittle transition temperature of a coach peel seam weld zone of the above-described high-strength steel sheet is −40° C. or less.

(6)

A manufacturing method of a hot-dip plated high-strength steel sheet for presswork excellent in low-temperature toughness and corrosion resistance is characterized in that it includes, in a manufacturing method of manufacturing the hot-dip plated high-strength steel sheet for presswork excellent in low-temperature toughness and corrosion resistance according to any one of the above-described (1) to (5), a step of obtaining a slab by making a molten steel having a chemical composition same as a chemical composition of the cold-rolled steel sheet according to the above-described (1) or (2) to be subjected to continuous casting, a step of obtaining a hot-rolled coil by heating the above-described slab at 1050 to 1245° C. for a period of time within 5 hours, completing, after the heating, hot rolling at a finishing temperature of Ar₃ to 910° C. to produce a hot-rolled steel sheet, and then coiling the hot-rolled steel sheet at a temperature of 750° C. or less, a step of performing cold rolling on the above-described hot-rolled steel sheet at a cold-rolling ratio of 50% or more to produce a cold-rolled steel sheet, and then obtaining a cold-rolled coil, and a step of performing annealing on the above-described cold-rolled steel sheet at a temperature of recrystallization temperature or more, and then performing hot-dipping.

(7)

It is characterized in that in the manufacturing method of the hot-dip plated high-strength steel sheet for presswork excellent in low-temperature toughness and corrosion resistance according to the above-described (6), hot-dipping containing Zn of 1.0 to 8.8 mass % and a balance composed of Sn and inevitable impurities, and whose plating deposition amount is 10 to 150 g/m² per one side is performed in the step of performing the hot-dipping.

(8)

It is characterized in that in the manufacturing method of the hot-dip plated high-strength steel sheet for presswork excellent in low-temperature toughness and corrosion resistance according to the above-described (6) or (7), pre-plating of Fe—Ni is performed before performing the hot-dipping in the step of performing the hot-dipping.

### Effect of the Invention

According to the present invention, it is possible to provide a hot-dip plated high-strength steel sheet fbr presswork having a tensile strength of 340 MPa or more and less than 540 MPa, a press formability capable of being applied to a field of automobile, particularly a fuel tank, excellent secondary work brittleness resistance and toughness of coach peel weld zone at low temperature, and excellent corrosion resistance.

### BRIEF DESCRIPTION OF THE DRAWINGS

FIG. 1 are diagrams showing an appearance of a surface of base steel sheet after being subjected to annealing, and a spectrum of composite oxide remained on the surface, in which FIG. 1(a) shows a photograph of scanning electron microscope (SEM) of the surface of the base steel sheet, and FIG. 1(b) shows an energy dispersive X-ray (EDX) analysis result of the composite oxide remained on the surface of the base steel sheet positioned at a pointed tip of arrow mark shown in FIG. 1(a);

FIG. 2 are diagrams showing an appearance of a surface of base steel sheet after being subjected to pickling after hot rolling, and a spectrum of oxide remained on the surface, in which FIG. 2(a) shows a photograph of scanning electron microscope (SEM) of the surface of the base steel sheet, and FIG. 2(b) shows an energy dispersive X-ray (EDX) analysis result of the composite oxide remained on the surface of the base steel sheet positioned at a pointed tip of arrow mark shown in FIG. 2(a);

FIG. 3 are diagrams showing an appearance of a surface of base steel sheet after degreasing and pickling and right before plating, and a spectrum of composite oxide remained on the surface, in which FIG. 3(a) shows a photograph of scanning electron microscope (SEM) of the surface of the base steel sheet, and FIG. 3(b) shows an energy dispersive X-ray (EDX) analysis result of the composite oxide remained on the surface of the base steel sheet positioned at a pointed tip of arrow mark shown in FIG. 3(a);

FIG. 4 is a diagram showing a relationship between “Si content in steel sheet” and “area ratio of oxide remained on surface of steel sheet after degreasing and pickling, and right before plating”;

FIG. 5 is a diagram showing a relationship between “area ratio of oxide” and “SST red rust generation ratio”;

FIG. 6 is a diagram showing a cross section of test piece having a coach peel seam weld zone;

FIG. 7 is a diagram showing an influence of Ti amount and B amount on a ductile-brittle transition temperature of the coach peel seam weld zone;

FIG. 8 are diagrams showing one example of a fracture surface when a fracture occurs by giving an impact after a heat treatment test in which a weld heat-affected zone is simulated, in which FIG. 8(a) shows a SEM photograph of the fracture surface, and FIG. 8(b) shows an enlarged SEM photograph of a part surrounded by a quadrangular frame in FIG. 8(a);

FIG. 9 is a diagram showing a test method of evaluating a secondary work brittleness resistance; and

FIG. 10 is a diagram showing an influence of P amount and B amount on the secondary work brittleness resistance.

### MODE FOR CARRYING OUT THE INVENTION

The present inventor conducted earnest studies regarding a method of solving the problems which are difficult to be solved by the conventional techniques, such that “a hot-dip plated high-strength steel sheet for presswork having excellent press firmability, excellent secondary work brittleness resistance and toughness of coach peel weld zone at low temperature, and excellent corrosion resistance is obtained”.

As a result of this, the present inventor found out that by regulating respective amounts of Ti, B, P, Al and Si to fall within specific ranges, it is possible to realize a hot-dip plated high-strength steel sheet for presswork having a tensile strength of 340 MPa or more and less than 540 MPa, a press formability capable of being applied to a field of automobile, particularly a fuel tank, excellent secondary work brittleness resistance and toughness of coach peel weld zone at low temperature, and excellent corrosion resistance.

A hot-dip plated high-strength steel sheet for presswork excellent in low-temperature toughness and corrosion resistance of the present invention (which is sometimes referred to as “steel sheet of the present invention”, hereinafter) is made based on the above-described findings, and is characterized in that in a high-strength steel sheet having a hot-dip plated layer on a surface of a cold-rolled steel sheet, the above-described cold-rolled steel sheet contains, by mass %, C: 0.0005 to 0.0050%, Si: 0.30% or less, Mn: 0.70 to 3.00%, P: 0.05% or less, Ti: 0.01 to 0.05%, Nb: 0.01 to 0.04%, B: 0.0005 to 0.0030%, S: 0.01% or less, Al: 0.01 to 0.30%, N: 0.0005 to 0.010%, and a balance composed of Fe and inevitable impurities, in which when the Ti content (%) is set to [Ti], the B content (%) is set to [B], and the P content (%) is set to [P], TB* defined by the following expression <A> is 0.03 to 0.06, and [B] and [P] satisfy the following expression <B>.

TB*=(0.11−[Ti])/(ln([B]×10000)) <A>

[P]≦10×[B]+0.03 <B>

First, reasons for limiting a chemical composition of the steel sheet of the present invention will be described. Hereinafter, % indicated in the chemical composition means mass %.

C: 0.0005 to 0.0050%

C is an important element that couples with Nb and Ti to form carbides, and contributes to an improvement of strength. Even ifa C amount is small, the strength can be compensated by another strengthening method, but, when the C amount is less than 0.0005%, it is difficult to secure the strength, and further, a decarburization cost during steelmaking is increased, so that a lower limit of the C amount is set to 0.0005%. The lower limit is preferably 0.0010% or more.

On the other hand, if the C content exceeds 0.0050%, even if Ti and Nb fixing C are added, a workability is lowered, and a toughness of a coach peel seam weld zone is lowered, so that an upper limit of the C content is set to 0.0050%. When extremely high workability and toughness of weld zone are required, the C content is preferably set to 0.0030% or less.

Si: 0.30% or less

Si is an element that contributes to an improvement of strength through solid-solution strengthening, and the present inventor conducted a salt spray test (SST) conducted under a severe environment compared to an actual environment of fuel tank, and set an upper limit of a content of Si based on a result of the test.

The prevent inventor conducted earnest studies regarding a mechanism in which a red rust is generated on a surface of steel sheet, based on the result of the salt spray test (SST). As a result of this, the present inventor found out that on the surface of steel sheet, there exists “fine oxide” estimated to be remained after degreasing and pickling right before plating, in a deep portion of very small plating defect estimated to deteriorate the corrosion resistance.

Here, FIG. 3 show an appearance of a surface of base steel sheet after degreasing and pickling and right before plating, and a spectrum of composite oxide remained on the surface. FIG. 3(a) shows a photograph of scanning electron microscope (SEM) of the surface of the base steel sheet, and FIG. 3(b) shows an energy dispersive X-ray (EDX) analysis result of the composite oxide remained on the surface of the base steel sheet positioned at a pointed tip of arrow mark shown in FIG. 3(a). The composite oxide remained on the surface of the base steel sheet in FIG. 3(a) includes one having a size of about 2 μm.

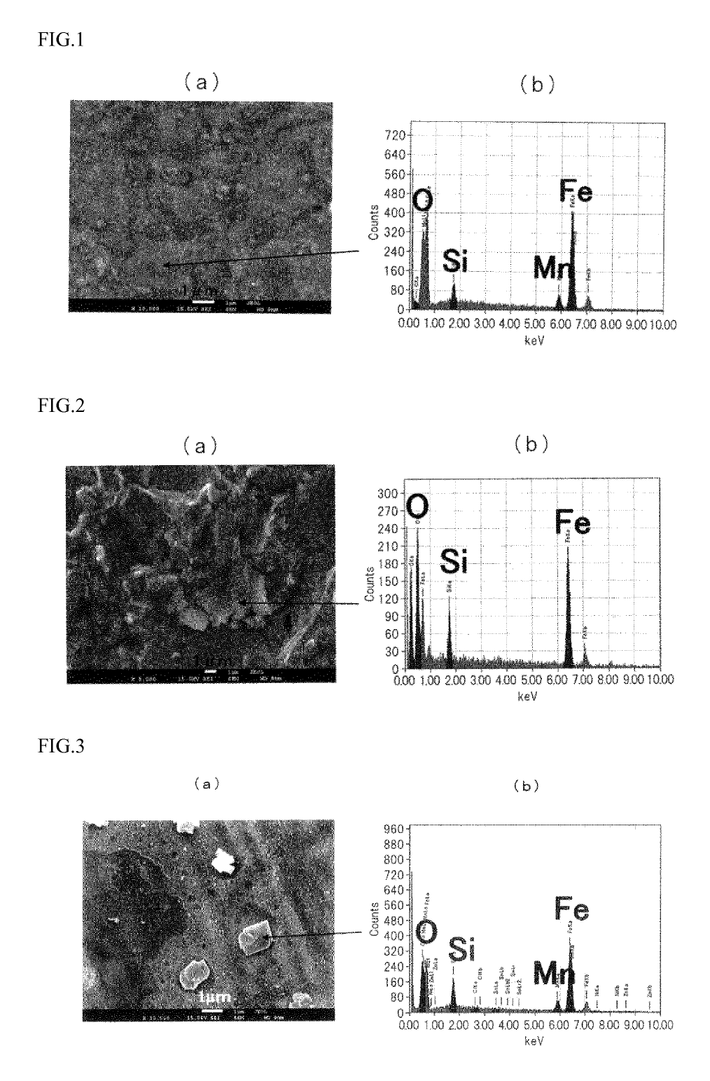

Further, FIG. 1 show an appearance of a surface of base steel sheet at a processing stage before conducting the degreasing and the pickling applied to the base steel sheet in FIG. 3, and after performing annealing, and a spectrum of composite oxide remained on the surface. FIG. 1(a) shows a photograph of scanning electron microscope (SEM) of the surface of the base steel sheet, and FIG. 1(b) shows an energy dispersive X-ray (EDX) analysis result of the composite oxide remained on the surface of the base steel sheet positioned at a pointed tip of arrow mark shown in FIG. 1(a).

As a comparison, FIG. 2 show an appearance of a surface of base steel sheet at a processing stage before performing the annealing on the base steel sheet in FIG. 1 and after pickling is conducted after hot rolling, and a spectrum of oxide remained on the surface. FIG. 2(a) shows a photograph of scanning electron microscope (SEM) of the surface of the base steel sheet, and FIG. 2(b) shows an energy dispersive X-ray (EDX) analysis result of the composite oxide remained on the surface of the base steel sheet positioned at a pointed tip of arrow mark shown in FIG. 2(a).

Although the reason why the fine oxide remains even if the degreasing and the pickling are conducted before plating is not clear, on a surface of steel sheet after being subjected to annealing in a CAPL (continuous annealing and processing line), a composite oxide containing Si and Mn is remained, as shown in FIG. 1. FIG. 2 show, as a comparison, an oxide remained on a surface of steel sheet after being subjected to pickling after hot rolling, in which the oxide is an oxide containing only Si.

As described above, the oxide remained on the surface of steel sheet after being subjected to the annealing in the CAPL (continuous annealing and processing line) is complicated by being affected by an atmosphere. Therefore, even if the degreasing and the pickling are performed on the surface of steel sheet, it is not possible to completely remove the oxide from the surface of steel sheet, and thus the fine oxide remains.

The present inventor further conducted earnest studies, and as a result of this, it was found out that if an area ratio of oxide remained on the surface of steel sheet is 3% or less in the entire surface, a size of each oxide becomes very small, and hot-dipping is performed on a surface of base steel sheet with this surface state, resulting in that a surface defect is decreased, and a corrosion resistance as a hot-dip plated steel sheet is remarkably improved. Further, it was found out that in order to set the area ratio of oxide to 3% or less, it is required to set the content of Si to 0.3% or less.

Next, the present inventor examined a relationship between “Si content in steel sheet” and “area ratio of oxide remained on surface of steel sheet after degreasing and pickling and right before plating”, and a relationship between “area ratio of oxide” and “SST red rust generation ratio”.

FIG. 4 shows the relationship between the “Si content in steel sheet” and the “area ratio of oxide remained on surface of steel sheet after degreasing and pickling and right before plating”. FIG. 5 shows the relationship between the “area ratio of oxide” and the “SST red rust generation ratio”. Note that the chemical composition of the steel sheet used in FIG. 4 and FIG. 5 is as follows, C: 0.0005 to 0.0050%, Si: 1.5% or less, Mn: 0.70 to 3.00%, P: 0.05% or less, Ti: 0.01 to 0.05%, Nb: 0.01 to 0.04%, B: 0.0005 to 0.0030%, S: 0.01% or less, Al: 0.01 to 0.30%, N: 0.0005 to 0.010%, and a balance composed of Fe and inevitable impurities.

From FIG. 4, it can be understood that if the “Si content in steel sheet” is 0.30% or less, the “area ratio of oxide remained on surface of steel sheet after degreasing and pickling and right before plating” can be maintained to 3% or less. Further, from FIG. 5, it can be understood that if the above-described “area ratio of oxide” is 3% or less, the “SST red rust generation ratio” can be maintained to less than 10%. Specifically, by setting the “Si content in steel sheet” to 0.30% or less, the corrosion resistance of the surface of the hot-dip plated steel sheet is remarkably improved.

Based on the above-described findings, an upper limit of the content of Si is set to 0.30%. The upper limit is preferably 0.25% or less. When the content of Si is 0.25% or less, the above-described “area ratio of oxide” can be reduced to 2% or less (refer to FIG. 4), and the “SST red rust generation ratio” can be reduced to less than 6% (refer to FIG. 5). The upper limit of the content of Si is more preferably 0.20% or less.

By setting the content of Si to 0.30% or less, it becomes possible to remove the scale (oxide) generated on the surface of the base steel sheet without performing grinding with the use of a brush for heavy duty grinding, which is normally conducted in a hot-dip galvanized steel sheet, resulting in that the corrosion resistance is improved. A biofiel has a strong corrosiveness, so that a hot-dip galvanized steel sheet containing Si of 0.30% or less is suitable for a steel sheet for a tank fotr biofuel. Note that a lower limit of the content of Si is preferably set to 0.01%, and is more preferably set to 0.02%, from a point of view of an improvement of strength through solid-solution strengthening and an improvement of workability.

Mn: 0.70 to 3.00%

Mn is an element that contributes to an improvement of strength through solid-solution strengthening and/or refining of structures, similar to Si, and is an important element for increasing the strength of the steel sheet of the present invention for the purpose of improving the secondary work brittleness resistance, the toughness of weld zone, and the hot-dip platability.

If a Mn content is less than 0.70%, an effect of improving the strength cannot be obtained, and further, when the effect of improving the strength is tried to be supplemented by adding another element, it is not possible to obtain target secondary work brittleness resistance, target toughness of weld zone, and target hot-dip platability (plating wettability with respect to the surface of steel sheet), so that a lower limit of the Mn content is set to 0.70%, and is preferably set to 1.00% or more. If the Mn content is 1.00% or more, structures of the steel sheet can be controlled even if a hot-rolling finishing temperature is lowered to 910° C. or less, and as a result of this, it is possible to improve the low-temperature toughness.

On the other hand, if the Mn content exceeds 3.00%, an in-plane anisotropy of r value being an index of deep drawability becomes large, resulting in that the press formability is impaired, and the hot-dip platability is impaired due to a generation of Mn oxide on the surface of steel sheet, so that an upper limit of the Mn content is set to 3.00%, and is preferably set to 2.50% or less.

P: 0.05% or less

P is an element which hardly causes the deterioration of workability, and contributes to an improvement of strength through solid-solution strengthening, but, it is also an element that deteriorates the secondary work brittleness resistance by being segregated at a grain boundary, and deteriorates the toughness of the coach peel seam weld zone by solidifying and segregating at the weld zone.

Further, P is an element which is segregated at the surface of steel sheet due to a thermal history up to when the hot-dipping is conducted, to thereby deteriorate the hot-dip platability. If a P content exceeds 0.05%, these segregations are caused, so that an upper limit of the P content is set to 0.05%, preferably set to 0.04% or less, and more preferably set to 0.035% or less.

Although there is no need to particularly define a lower limit of the P content, if the P content is reduced to less than 0.005%, a refining cost is increased, so that the P content is preferably 0.005% or more. Further, the P content is preferably 0.02% or more in terms of securement of strength.

Ti: 0.01 to 0.05%

Ti is an element which has a strong affinity with C and N, and forms carbonitrides during solidification or during hot rolling to reduce C and N solid-solved in the steel, thereby contributing to an improvement of workability. If a Ti content is less than 0.01%, an effect of adding Ti cannot be achieved, so that a lower limit of the Ti content is set to 0.01%, and is preferably set to 0.015% or more.

On the other hand, if the Ti content exceeds 0.05%, the toughness of weld zone of welded joint, namely, the toughness of the coach peel seam weld zone deteriorates, so that an upper limit of the Ti content is set to 0.05%, and is preferably set to 0.04% or less.

Nb: 0.01 to 0.04%

Nb is, similar to Ti, an element which has a strong affinity with C and N, and forms carbonitrides during solidification or during hot rolling to reduce C and N solid-solved in the steel, thereby contributing to an improvement of workability. If a Nb content is less than 0.01%, an effect of adding Nb cannot be achieved, so that a lower limit of the Nb content is set to 0.01%, and is preferably set to 0.02% or more

On the other hand, if the Nb content exceeds 0.04%, a recrystallization temperature becomes high, high-temperature annealing has to be conducted, and the toughness of weld zone of welded joint, namely, the toughness of coach peel seam weld zone deteriorates, so that an upper limit of the Nb content is set to 0.04%, and is preferably set to 0.035% or less.

B: 0.0005 to 0.0030%

B is an element that contributes to the improvement of secondary work brittleness resistance by being segregated at a grain boundary to increase the grain boundary strength. If a B content is less than 0.0005%, an effect of adding B cannot be achieved, so that a lower limit of the B content is set to 0.0005%, preferably set to 0.0008% or more, and more preferably set to 0.0010% or more.

On the other hand, if the B content exceeds 0.0030%, B is segregated at γ grain boundary during welding to suppress a ferrite transformation, structures of the weld zone and the heat-affected zone become structures generated by low-temperature transformation, and the weld zone and the heat-affected zone are hardened and the toughness deteriorates, resulting in that the toughness of the coach peel seam weld zone deteriorates, so that an upper limit of the B content is set to 0.0030%.

Further, if a large amount of B is added, a ferrite transformation during hot rolling is also suppressed, resulting in that a high-strength hot-rolled steel sheet having a structure generated by low-temperature transformation is produced, and a load during cold rolling becomes high, so that from this point as well, the upper limit of the B content is set to 0.0030%.

Further, if the B content exceeds 0.0030%, the recrystallization temperature becomes high, and annealing at high temperature has to be conducted, which increases manufacturing costs, and at the same time, the in-plane anisotropy of r value being the index of deep drawability becomes large, and the press formability deteriorates, so that from this point as well, the upper limit of the B content is set to 0.0030%, and is preferably set to 0.0025% or less.

S: 0.01% or less

S, being an inevitably mixed impurity, couples with Mn and Ti to form precipitates to deteriorate the workability, so that a content of S is regulated to 0.01% or less, and is preferably set to 0.005% or less. Although a lower limit of S content includes 0%, if the S content is reduced to less than 0.0001%, a manufacturing cost is increased, so that the S content is preferably 0.0001% or more, and is more preferably set to 0.001% or more.

Al: 0.01 to 0.30%

Al is an element used as a deoxidizer at a time of refining steel, but, it is also an element which worsens the low-temperature toughness of the weld zone and the secondary work brittleness resistance if a content thereof is too much. Accordingly, in the present invention, it is important to regulate the Al content. If the Al content is less than 0.01%, an effect of deoxidation cannot be achieved, so that a lower limit of the Al content is set to 0.01%, and is preferably set to 0.03% or more. On the other hand, if the Al content exceeds 0.30%, the toughness of the coach peel seam weld zone is lowered, and further, the workability is lowered, so that an upper limit of the Al content is set to 0.30%, preferably 0.20% or less, more preferably less than 0.10%, and an optimum value thereof is 0.075% or less.

N: 0.0005 to 0.010% N, being an element inevitably mixed at a time of refining steel, forms nitrides with Ti, Al and Nb, and although it does not exert adverse effect on the workability, it deteriorates the toughness of the weld zone, so that a content of N is regulated to 0.010% or less, and is preferably set to 0.007% or less. On the other hand, if the N content is reduced to less than 0.0005%, a manufacturing cost is increased, so that a lower limit of the N content is set to 0.0005%, and is preferably set to 0.0010% or more.

TB*: 0.03 to 0.06

TB*=(0.11−[Ti])/(ln([B]×10000)) <A>

The present inventor found out that if TB* (index of strength of coach peel seam weld zone) defined by the above-described expression <A> in which the content of Ti and the content of B which exert an influence on the toughness of the coach peel seam weld zone are set to [Ti] and [B], respectively, becomes small, a tensile strength of the coach peel seam weld zone is lowered.

When the TB* is less than 0.03, a tensile strength at low temperature is significantly lowered. This is because a brittle fracture easily occurs due to the reduction in low-temperature toughness.

Hereinafter, a test from which the present inventor obtained this finding will be described.

Steels in which compositions were changed in ranges of C: 0.0005 to 0.0050%, Si: 0.30% or less, Mn: 0.70 to 3.00%, P: 0.05% or less, Ti: 0.09% or less, Nb: 0.01 to 0.04%, B: 0.03% or less, S: 0.01% or less, Al: 0.01 to 0.30%, and N: 0.0005 to 0.010%, were produced in a vacuum melting furnace.

Each of the produced steels was heated at 1200° C. for 1 hour, the resultant was then subjected to hot rolling, and the hot rolling was completed at a finishing temperature of 880 to 910° C., thereby obtaining a hot-rolled sheet with a thickness of 3.7 mm. This hot-rolled sheet was pickled, and then subjected to cold rolling, thereby obtaining a cold-rolled sheet with a thickness of 1.2 mm. This cold-rolled sheet was subjected to annealing at 800° C. for 60 seconds, the resultant was then subjected to Fe—Ni plating of 1 g/m², and then subjected to Sn—Zn plating using a flux method.

As the Fe—Ni plating bath, a Watts bath of Ni plating to which 100 g/L of iron sulfate was added, was used. As a flux, an aqueous solution of ZnCl₂—NH₄Cl was applied by a roll. The plating was conducted in a Sn—Zn plating bath containing Zn of 7 wt %. A bath temperature was set to 280° C., and after the plating, a plating deposition amount was adjusted by gas wiping.

Further, the steel sheet after being subjected to the hot-dipping was subjected to treatment in which Cr³⁺ was mainly used, thereby obtaining a hot-dip plated steel sheet. By using the hot-dip plated steel sheet, the toughness of the coach peel seam weld zone was evaluated. The evaluation was conducted in the following manner.

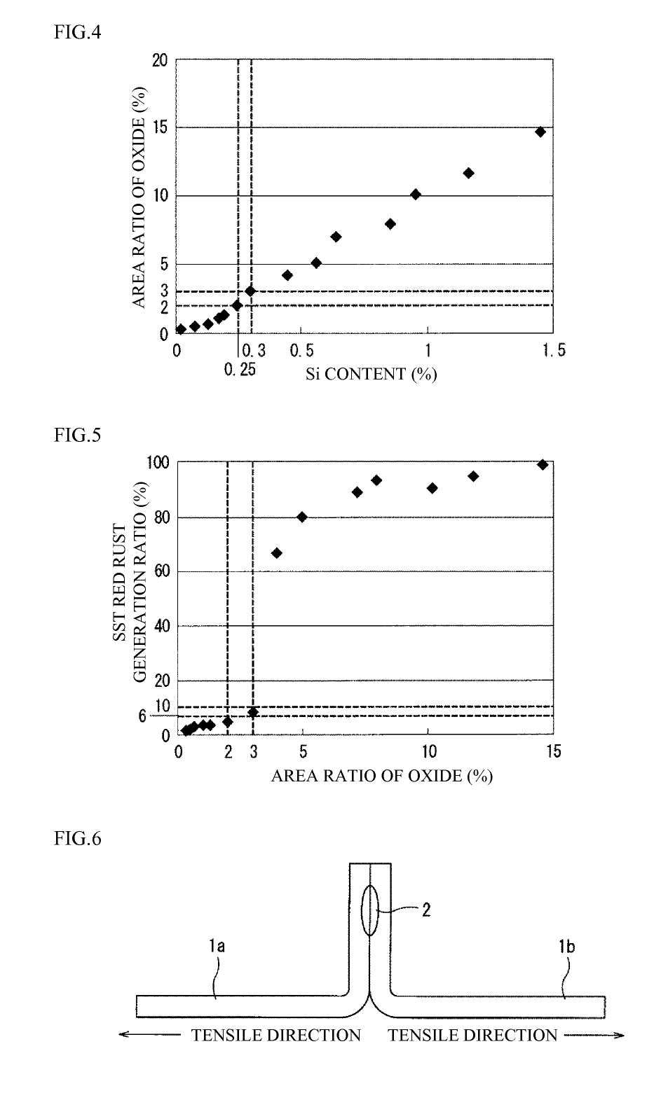

As illustrated in FIG. 6, hot-dip plated steel sheets 1a, 1b after being subjected to bending were faced each other in a coach peel configuration and seam-welded, to thereby produce a test piece having a weld zone 2 (coach peel seam weld zone). Horizontal parts of the hot-dip plated steel sheets 1a, 1b were fixed by a chuck, a tensile force was applied (peel test was conducted) at a rate of 200 mm/min under various temperatures, and after a fracture occurred, a fracture surface was examined. In the fracture surface, a temperature at which a percentage of brittle fracture surface and that of ductile fracture surface became 50% and 50%, was set to a ductile-brittle transition temperature (° C.).

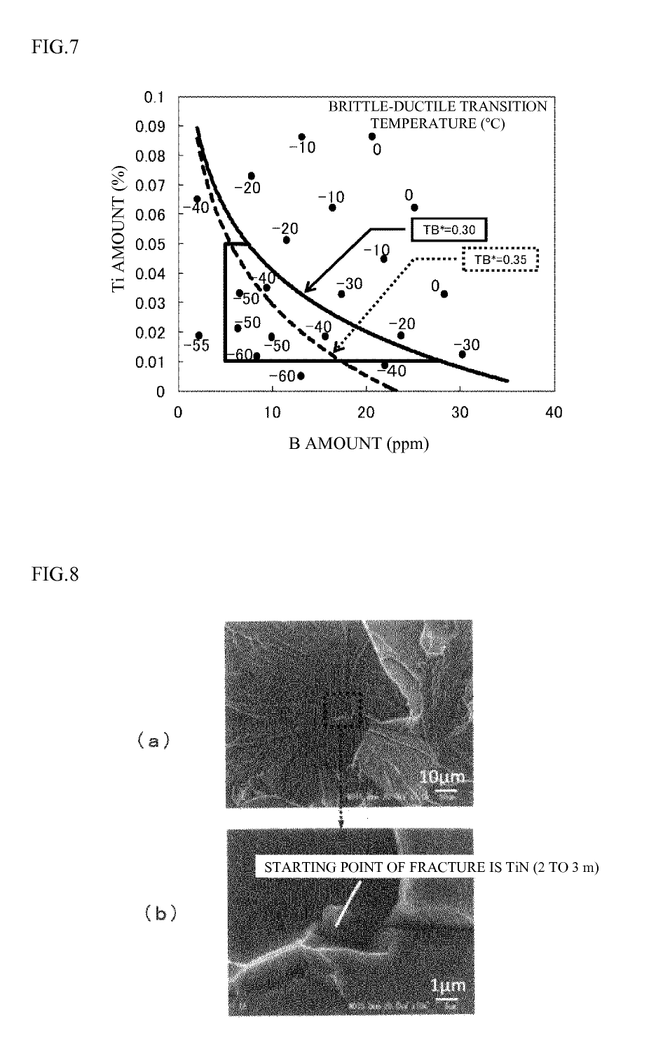

FIG. 7 shows an influence of Ti amount and B amount on the ductile-brittle transition temperature of the coach peel seam weld zone, in which a horizontal axis indicates the B amount (ppm), and a vertical axis indicates the Ti amount (%). The ductile-brittle transition temperature is preferably in a temperature range in which a temperature corresponding to the lowest temperature (−40° C.) in a cold district in which an automobile is used is set to an upper limit, namely, it is preferably −40° C. or less, and is more preferably −50° C. or less.

As illustrated in FIG. 7, if TB* defined by the following expression <A> is 0.03 or more, the ductile-brittle transition temperature can be set to −40° C. or less, and if the TB* is 0.035 or more, the ductile-brittle transition temperature can be set to −50° C. or less.

TB*=(0.11−[Ti])/(ln([B]×10000)) <A>

Based on the above-described test results, it is possible to make a deduction as follows.

(i) When the Ti amount is large, TiN is generated, which becomes a starting point of fracture. FIG. 8 show an example of fracture surface when a cold-rolled steel sheet in which a Ti amount is 0.1% and thus exceeds 0.05%, and the other components fall within the range of the present invention is manufactured, the steel sheet is subjected to a heat treatment test in which a welding is simulated, and the steel sheet is fractured after an impact is given thereto (FIG. 8(a) shows a fracture surface when the fracture occurs, and FIG. 8(b) shows an enlarged fracture surface of a part surrounded by a quadrangular frame in FIG. 8(a)), in which it can be considered that when the Ti amount is large, TiN of about 2 to 3 m is generated, which becomes a starting point of fracture.

(ii) When the B amount is large, the hardness of the weld zone and the heat-affected zone is increased, or the hardened region is enlarged, resulting in that when a tensile force acts on the coach peel seam weld zone (refer to FIG. 6), the coach peel seam weld zone is difficult to be deformed. Therefore, it can be considered that the stress concentrates in one part to be locally increased, resulting in that the toughness is lowered.

It can be considered that since the influences of (i) and (ii) coexist, even if the contents of Ti and B are within the above-described ranges, the low-temperature toughness deteriorates when the TB* is less than its lower limit value (0.03).

Based on the above-described test results and deduction, the TB* is set to 0.03 or more. The TB* is preferably 0.035 or more. An upper limit of the TB* is 0.06 based on the ranges of the Ti amount and the B amount.

[P]≦10×[B]+0.03

The present inventor found out that if the P content ([P]) and the B content ([B]) are controlled to maintain a relationship defined by the following expression <B>, the secondary work brittleness resistance is improved.

[P]≦10×[B]+0.03 <B>

Hereinafter, a test from which the present inventor obtained this finding and results thereof will be described.

The present inventor produced steels in which compositions were changed in ranges of C: 0.0005 to 0.0050%, Si: 0.30% or less, Mn: 0.70 to 3.00%, P: 0.09% or less, Ti: 0.01 to 0.05%, Nb: 0.01 to 0.04%, B: 0.0030% or less, S: 0.01% or less, Al: 0.01 to 0.30%, and N: 0.0005 to 0.010%, in a vacuum melting furnace.

Each of the produced steels was heated at 1200° C. for 1 hour, the resultant was then subjected to hot rolling, and the hot rolling was completed at a finishing temperature of 880 to 910° C., thereby obtaining a hot-rolled sheet with a thickness of 3.7 mm. This hot-rolled sheet was pickled, and then subjected to cold rolling, thereby obtaining a cold-rolled sheet with a thickness of 1.2 mm. This cold-rolled sheet was subjected to annealing at 800° C. for 60 seconds, the resultant was then subjected to Fe—Ni plating of 1 g/m², and then subjected to Sn—Zn plating using a flux method.

As the Fe—Ni plating bath, a Watts bath of Ni plating to which 100 g/L of iron sulfate was added, was used. As a flux, an aqueous solution of ZnCl₂—NH₄Cl was applied by a roll. The plating was conducted in a Sn—Zn plating bath containing Zn of 7 wt %. A bath temperature was set to 280° C., and after the plating, a plating deposition amount was adjusted by gas wiping.

Further, the steel sheet after being subjected to the hot-dipping was subjected to treatment in which Cr³⁺ was mainly used, thereby obtaining a hot-dip plated steel sheet. By using the hot-dip plated steel sheet, the secondary work brittleness resistance temperature was examined. The examination was conducted in the following manner.

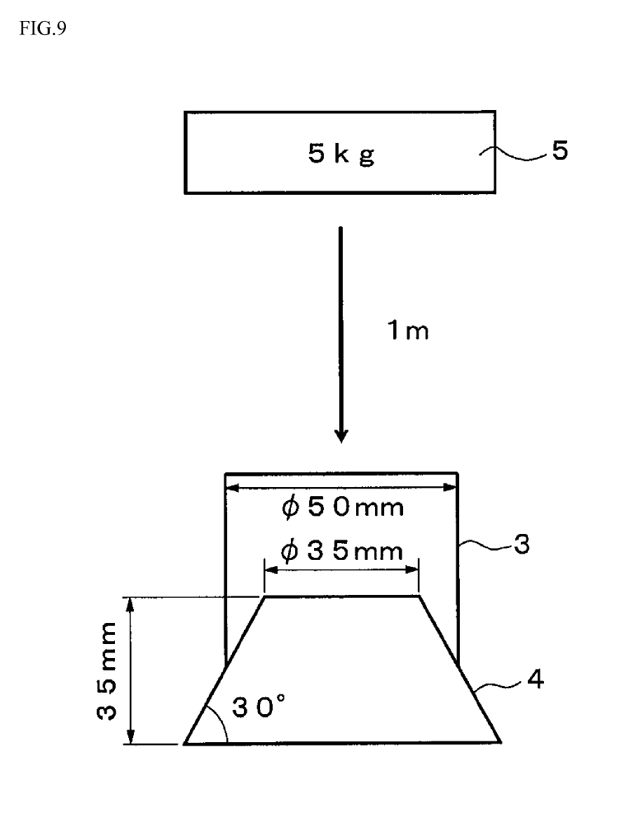

A blank material with a diameter of 95 mm was collected from the hot-dip plated steel sheet, and a cylindrical drawing with a drawing ratio of 1.9 was performed using a punch with an outside diameter of 50 mm, to thereby manufacture a drawn cup. FIG. 9 shows a test method of evaluating the secondary work brittleness resistance. As shown in FIG. 9, a drawn cup 3 was placed upside down on a truncated cone 4 with a base angle of 30°, a weight 5 having a weight of 5 kg was dropped from a position of a height of 1 m under various temperature conditions, and the lowest temperature at which no crack occurred on the drawn cup (secondary work brittleness resistance temperature) was examined.

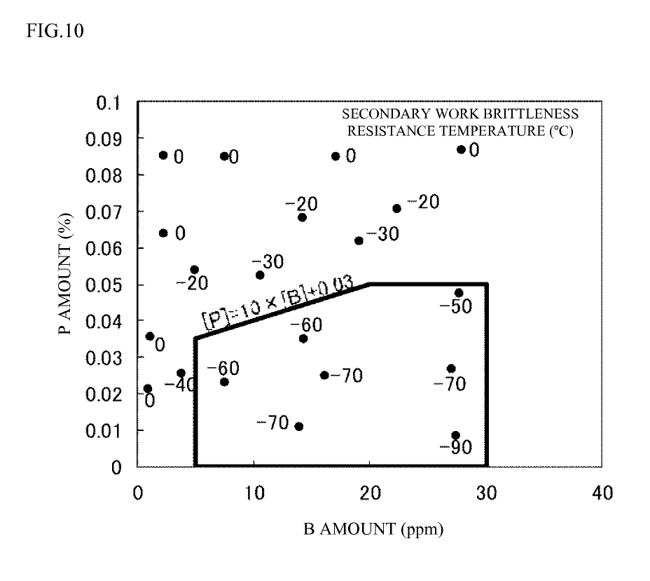

Results thereof are presented in FIG. 10, as an influence of P amount (%) and B amount (ppm) on the secondary work brittleness resistance. The working of the steel sheet for fuel tank is normally conducted with a drawing ratio corresponding to 1.9 or less, so that the secondary work brittleness resistance temperature after performing the forming work at a drawing ratio of 1.9 is preferably in a temperature range in which a temperature corresponding to the lowest temperature (−40° C.) in a cold district in which an automobile is used is set to an upper limit, namely, it is preferably −40° C. or less, and is more preferably −50° C. or less.

As shown in FIG. 10, if the P amount (%) ([P]) and the B amount (%) ([B]) satisfy the following expression <B>, the secondary work brittleness resistance temperature after performing the forming work at the drawing ratio of 1.9 can be set to −50° C. or less.

[P]≦10×[B]+0.03 <B>

One or two or more of Cu: 0.005 to 1%, Ni: 0.005 to 1%, Cr: 0.005 to 1%, and Mo: 0.0005 to 1%

The present inventor found out that by further adding Cu, Ni, Cr and Mo, in addition to the above-described basic composition, it is possible to lower the yield strength (YP) and to secure the workability while securing the tensile strength. For this reason, in the present invention, it is set that Cu, Ni, Cr and Mo are appropriately contained according to need.

Each content of Cu, Ni and Cr is preferably set to 0.005% or more by which an effect of adding the element can be achieved, and is more preferably set to 0.01% or more. A content of Mo is set to 0.0005% or more by which an effect of adding Mo can be achieved, and is preferably set to 0.001% or more.

On the other hand, if each content of Cu, Ni, Cr and Mo exceeds 1%, the secondary work brittleness resistance and the toughness of the coach peel seam weld zone are lowered, and an alloy cost is increased, so that each content of Cu, Ni, Cr and Mo is set to 1% or less, preferably set to 0.5% or less, and more preferably, each content of Cu and Mo is set to 0.25% or less, and each content of Ni and Cr is set to 0.4% or less.

Note that the balance of the steel sheet of the present invention is composed of Fe and inevitable impurities.

The steel sheet of the present invention has the above-described chemical composition, so that it has a tensile strength of 340 MPa or more and less than 540 MPa, and a press formability capable of being applied to a field of automobile, particularly a fuel tank, and in addition to that, it is excellent in low-temperature toughness. Therefore, according to the steel sheet of the present invention, it becomes possible to improve a fuel economy by reducing a weight of vehicle body of an automobile, and in particular, it becomes possible to realize a reduction in weight and a complicated shape of a fuel tank. This effect is an extremely large effect from industrial point of view.

Next, a manufacturing method of the steel sheet of the present invention will be described.

A raw material in which amounts of respective elements are adjusted to achieve the above-described chemical composition, is put in a converter or an electric furnace, and a vacuum degassing treatment is conducted, to thereby manufacture a slab. The slab is heated at 1050 to 1245° C. for a period of time within 5 hours, hot rolling is completed at a finishing temperature of Ar₃ to 910° C. to produce a hot-rolled steel sheet, and thereafter, the hot-rolled steel sheet is coiled at a coiling temperature of 750° C. or less, to thereby obtain a hot-rolled coil.

A heating temperature of the slab is required to be 1050° C. or more for securing a rolling temperature, and in order to suppress the generation of coarse TiN which causes the reduction in toughness, to suppress the growth of coarse austenite grains, and further, to suppress a heating cost, the heating temperature of the slab is set to 1245° C. or less, and a heating time is set to 5 hours or less.

In particular, the coarse TiN reduces the toughness of the coach peel seam weld zone, so that heating conditions, in addition to the restriction of TB*, are important requirements. Although the technique described in Patent Documents 13 and 14 is a technique of improving the properties of base material, the toughness of the coach peel seam weld zone is lowered depending on the heating conditions and conditions regarding the TB*.

If the finishing temperature in the hot rolling is less than Ar₃, the workability of steel sheet is impaired, so that the finishing temperature is set to Ar₃ or more. By setting the finishing temperature in the hot rolling to 910° C. or less, it is possible to control structures of the steel sheet to improve the low-temperature toughness. Further, if the coiling temperature after the hot rolling exceeds 750° C., the strength of steel sheet after cold rolling and annealing is lowered, so that the coiling temperature is set to 750° C. or less.

The hot-rolled steel sheet produced in the above-described method is subjected to descaling, according to need, and then subjected to cold rolling at a rolling ratio of 50% or more, thereby obtaining a cold-rolled steel sheet with a predetermined sheet thickness. If the rolling ratio is less than 50%, the strength of steel sheet after annealing is lowered, and a deep drawability deteriorates. Note that the rolling ratio is preferably 65 to 80%, and at the rolling ratio, it is possible to obtain a hot-dip plated steel sheet with further excellent strength and deep drawability.

After that, the cold-rolled steel sheet is subjected to annealing at a temperature of equal to or more than a recrystallization temperature. If the annealing temperature is less than the recrystallization temperature, a good texture is not developed, and the deep drawability deteriorates. The annealing temperature is preferably equal to or more than “recrystallization temperature +20° C.”. On the other hand, if the annealing temperature becomes high, the strength of steel sheet is lowered, so that the annealing temperature is set to 850° C. or less, preferably set to 840° C. or less, and more preferably set to 830° C. or less.

In order to suppress an oxidation at the time of annealing, the annealing is preferably conducted in an atmosphere in which hydrogen of 20% or less is mixed in nitrogen, and a dew point is −60 to 0° C. If an operation load is also taken into consideration, an atmosphere in which hydrogen of 2 to 8% is mixed in nitrogen, and a dew point is −50 to −10° C. is more preferable.

Hot-dipping is performed on a surface of the cold-rolled steel sheet, to thereby produce a hot-dip plated steel sheet. The hot-dipping may be conducted in the middle of cooling after the annealing, and further, it may also be conducted by performing reheating after the annealing.

As the hot-dip plated steel sheet, one obtained by forming a hot-dip plated layer of Zn, Zn alloy, Al, Al alloy, Sn—Zn or the like on a surface of steel sheet, can be cited, and when the corrosion resistance is considered as important, a Sn—Zn hot-dip plated steel sheet having a hot-dip plated layer made of Zn of 1.0 to 8.8 mass %, and a balance composed of Sn and inevitable impurities, and whose plating deposition amount is 10 to 150 g/m² per one side, is preferable.

A chemical composition of the hot-dip plated layer is limited based on a balance between a corrosion resistance of an inner surface and that of an outer surface of a fuel tank. The outer surface of the fuel tank requires a perfect rust prevention performance, so that coating is performed after the forming. A thickness of coating determines the rust prevention performance, and in the steel sheet, the generation of red rust is prevented by a corrosion prevention performance of the hot-dip plated layer. In a portion which is not coated enough, the corrosion prevention performance of the hot-dip plated layer is extremely important.

By adding Zn to Sn-based plating, an electric potential of plating layer is lowered, resulting in that a sacrificial corrosion prevention performance is given. In order to achieve this, it is preferable to add Zn of 1.0 mass % or more to the plating layer, and it is more preferable to add Zn of 3.0 mass % or more to the plating layer.

However, if Zn exceeding 8.8 mass %, which corresponds to a binary Sn—Zn eutectic point, is added, a melting point is increased to facilitate the growth of coarse Zn crystal, and further, an excessive growth of intermetallic compound layer below the plating (so-called alloy layer) is facilitated, so that the content of Zn is set to 8.8 mass % or less, and is preferably set to 8.0 mass % or less.

A deposition amount of Sn—Zn plating is preferably set to 10 to 150 g/m² per one side. If the above-described deposition amount is less than 10 g/m² per one side, good corrosion resistance cannot be secured, and further, if the above-described deposition amount exceeds 150 g/m², a cost of plating is increased, and in addition to that, a layer thickness becomes non-uniform, resulting in that the plating layer exhibits a mottled appearance (defect), and further, the weldability is lowered. Therefore, the deposition amount of Sn—Zn plating is preferably set to 10 to 150 g/m² per one side, and is more preferably set to 20 to 130 g/m² per one side.

In order to improve the platability of Sn—Zn plating, it is preferable to perform, before the plating, pre-plating of Fe—Ni. The pre-plating of Fe—Ni is effective to increase the wettability of Sn—Zn plating, and to improve the corrosion resistance by refining primary crystal Sn.

The pre-plating of Fe—Ni is an important technique for effectively using Si and Mn which deteriorate the platability (plating wettability with respect to steel sheet), for increasing the strength, and is one of characteristics of the present invention. Note that the Fe—Ni pre-plating also exhibits an effect of improving the plating wettability when hot-dipping of Zn, Zn alloy, Al, Al alloy or the like, other than the Sn—Zn plating, is employed.

In the pre-plating of Fe—Ni, a deposition amount per one side is preferably 0.2 g/m² or more from a point of view of the plating wettability, and a proportion of Ni is preferably 10 to 70 mass % from a point of view of refining of primary crystal Sn.

In the hot-dip plated steel sheet of the present invention manufactured through the above-described method, it is also possible to further provide an electroplated layer on the surface of the hot-dip plated layer according to need.

### Examples

Hereinafter, the feasibility and the effect of the steel sheet of the present invention will be described based on invention examples and comparative examples, in which invention examples 1 to 20 are examples adopted for confirming the feasibility and the effect of the present invention, and the present invention is not limited to these invention examples 1 to 20. The present invention can adopt various conditions as long as the object of the present invention is achieved without departing from the gist of the present invention.

### Examples

Steel slabs having chemical compositions presented in Table 1 and Table 2 (continued from Table 1) were produced, the steel slabs were subjected to slab heating at temperatures and for periods of time presented in Table 3, hot rolling was then completed at finishing temperatures presented in Table 3, and coiling was conducted at coiling temperatures presented in Table 3, thereby obtaining hot-rolled sheets each having a thickness of 3.6 mm. Note that balances of the chemical compositions presented in Table 1 and Table 2 are composed of Fe and inevitable impurities. An underline in Table 1 and Table 2 indicates a value which is out of the present invention.

TABLE 1

| | STEEL | | | | | | | | | | |
|---|---|---|---|---|---|---|---|---|---|---|---|
| | No. | C | Si | Mn | P | S | Al | Ti | Nb | B | N |
| INVENTION | 1 | 0.0015 | 0.22 | 2.16 | 0.032 | 0.004 | 0.042 | 0.022 | 0.025 | 0.0009 | 0.0012 |
| EXAMPLE | 2 | 0.0005 | 0.04 | 1.37 | 0.035 | 0.002 | 0.035 | 0.015 | 0.026 | 0.0022 | 0.0020 |
| | 3 | 0.0030 | 0.30 | 1.49 | 0.025 | 0.003 | 0.048 | 0.018 | 0.030 | 0.0012 | 0.0021 |
| | 4 | 0.0021 | 0.28 | 2.75 | 0.011 | 0.005 | 0.030 | 0.019 | 0.015 | 0.0007 | 0.0034 |
| | 5 | 0.0029 | 0.12 | 2.33 | 0.040 | 0.002 | 0.057 | 0.024 | 0.029 | 0.0017 | 0.0037 |
| | 6 | 0.0020 | 0.01 | 0.72 | 0.042 | 0.002 | 0.145 | 0.014 | 0.035 | 0.0024 | 0.0012 |
| | 7 | 0.0025 | 0.18 | 0.84 | 0.018 | 0.004 | 0.054 | 0.012 | 0.024 | 0.0011 | 0.0025 |
| | 8 | 0.0024 | 0.09 | 1.93 | 0.022 | 0.003 | 0.049 | 0.022 | 0.025 | 0.0015 | 0.0020 |
| | 9 | 0.0010 | 0.13 | 0.99 | 0.034 | 0.010 | 0.036 | 0.024 | 0.018 | 0.0010 | 0.0010 |
| | 10 | 0.0033 | 0.21 | 1.57 | 0.015 | 0.003 | 0.072 | 0.020 | 0.030 | 0.0016 | 0.0046 |
| | 11 | 0.0022 | 0.17 | 1.07 | 0.032 | 0.005 | 0.047 | 0.011 | 0.035 | 0.0014 | 0.0023 |
| | 12 | 0.0020 | 0.07 | 1.16 | 0.027 | 0.003 | 0.062 | 0.029 | 0.015 | 0.0005 | 0.0020 |
| | 13 | 0.0013 | 0.20 | 1.25 | 0.005 | 0.002 | 0.034 | 0.021 | 0.038 | 0.0018 | 0.0042 |
| | 14 | 0.0048 | 0.15 | 2.52 | 0.049 | 0.004 | 0.025 | 0.010 | 0.039 | 0.0028 | 0.0035 |
| | 15 | 0.0022 | 0.28 | 2.98 | 0.023 | 0.007 | 0.041 | 0.022 | 0.020 | 0.0007 | 0.0075 |
| | 16 | 0.0024 | 0.23 | 1.55 | 0.010 | 0.001 | 0.003 | 0.048 | 0.033 | 0.0007 | 0.0032 |
| | 17 | 0.0035 | 0.26 | 1.04 | 0.031 | 0.002 | 0.050 | 0.016 | 0.030 | 0.0022 | 0.0013 |
| | 18 | 0.0018 | 0.27 | 1.78 | 0.014 | 0.001 | 0.285 | 0.010 | 0.024 | 0.0006 | 0.0027 |
| | 19 | 0.0034 | 0.25 | 0.92 | 0.031 | 0.002 | 0.035 | 0.015 | 0.016 | 0.0018 | 0.0022 |
| | 20 | 0.0040 | 0.29 | 2.04 | 0.035 | 0.004 | 0.013 | 0.035 | 0.010 | 0.0008 | 0.0017 |
| COMPARATIVE | 21 | 0.0074 | 0.25 | 2.34 | 0.022 | 0.004 | 0.027 | 0.019 | 0.028 | 0.0019 | 0.0033 |
| EXAMPLE | 22 | 0.0035 | 0.95 | 2.76 | 0.034 | 0.003 | 0.042 | 0.012 | 0.021 | 0.0025 | 0.0024 |
| | 23 | 0.0013 | 0.11 | 3.68 | 0.019 | 0.004 | 0.083 | 0.023 | 0.022 | 0.0010 | 0.0025 |
| | 24 | 0.0022 | 0.30 | 0.72 | 0.075 | 0.003 | 0.026 | 0.025 | 0.013 | 0.0006 | 0.0027 |
| | 25 | 0.0024 | 0.16 | 1.45 | 0.011 | 0.005 | 0.063 | 0.003 | 0.036 | 0.0022 | 0.0022 |
| | 26 | 0.0032 | 0.09 | 0.89 | 0.035 | 0.004 | 0.027 | 0.091 | 0.031 | 0.0027 | 0.0029 |
| | 27 | 0.0042 | 0.02 | 1.54 | 0.044 | 0.002 | 0.039 | 0.020 | 0.002 | 0.0016 | 0.0039 |
| | 28 | 0.0023 | 0.24 | 1.98 | 0.021 | 0.004 | 0.031 | 0.021 | 0.017 | 0.0002 | 0.0032 |
| | 29 | 0.0024 | 0.08 | 2.12 | 0.025 | 0.005 | 0.033 | 0.017 | 0.013 | 0.0072 | 0.0017 |
| | 30 | 0.0013 | 0.12 | 1.11 | 0.048 | 0.003 | 0.052 | 0.031 | 0.024 | 0.0011 | 0.0024 |
| | 31 | 0.0042 | 0.09 | 1.80 | 0.071 | 0.008 | 0.037 | 0.025 | 0.032 | 0.0019 | 0.0014 |
| | 32 | 0.0018 | 0.28 | 0.90 | 0.025 | 0.002 | 0.005 | 0.021 | 0.016 | 0.0015 | 0.0036 |
| | 33 | 0.0023 | 0.25 | 1.58 | 0.035 | 0.002 | 0.824 | 0.015 | 0.025 | 0.0023 | 0.0072 |
| | 34 | 0.0033 | 0.13 | 1.61 | 0.018 | 0.003 | 1.132 | 0.019 | 0.033 | 0.0014 | 0.0024 |

TABLE 2

| | STEEL | | | | | | 10 × [B] + |
|---|---|---|---|---|---|---|---|
| | No. | Cu | Ni | Cr | Mo | TB* | 0.03 |
| INVENTION | 1 | — | — | — | — | 0.040 | 0.039 |
| EXAMPLE | 2 | — | — | — | — | 0.031 | 0.052 |
| | 3 | — | — | — | — | 0.037 | 0.042 |
| | 4 | 0.03 | — | — | — | 0.047 | 0.037 |
| | 5 | — | 0.02 | — | — | 0.030 | 0.047 |
| | 6 | — | — | 0.03 | — | 0.030 | 0.054 |
| | 7 | — | — | — | 0.005 | 0.041 | 0.041 |
| | 8 | — | 0.03 | 0.01 | — | 0.032 | 0.045 |
| | 9 | 0.24 | 0.01 | — | — | 0.037 | 0.040 |
| | 10 | — | — | 0.23 | 0.14 | 0.032 | 0.046 |
| | 11 | 0.02 | — | — | 0.005 | 0.038 | 0.044 |
| | 12 | — | 0.26 | 0.18 | 0.22 | 0.050 | 0.035 |
| | 13 | 0.02 | 0.05 | 0.03 | — | 0.031 | 0.048 |
| | 14 | 0.04 | 0.48 | 0.14 | 0.11 | 0.030 | 0.058 |
| | 15 | 0.01 | — | — | — | 0.045 | 0.037 |
| | 16 | — | — | 0.24 | 0.20 | 0.032 | 0.037 |
| | 17 | 0.02 | 0.35 | — | — | 0.030 | 0.052 |
| | 18 | — | 0.04 | 0.06 | 0.012 | 0.056 | 0.036 |
| | 19 | 0.23 | 0.02 | 0.26 | — | 0.033 | 0.048 |
| | 20 | 0.02 | 0.92 | 0.05 | 0.005 | 0.036 | 0.038 |
| COM- | 21 | — | — | — | — | 0.031 | 0.049 |
| PARATIVE | 22 | — | — | — | — | 0.030 | 0.055 |
| EXAMPLE | 23 | — | — | — | — | 0.038 | 0.040 |
| | 24 | — | — | — | — | 0.047 | 0.036 |
| | 25 | 0.02 | — | 0.01 | 0.003 | 0.035 | 0.052 |
| | 26 | — | 0.01 | 0.02 | 0.005 | 0.006 | 0.057 |
| | 27 | 0.01 | 0.03 | — | — | 0.032 | 0.046 |
| | 28 | — | 0.02 | — | 0.003 | 0.128 | 0.032 |
| | 29 | 0.02 | — | — | — | 0.022 | 0.102 |
| | 30 | 0.01 | 0.02 | — | 0.005 | 0.033 | 0.041 |
| | 31 | — | — | 0.02 | — | 0.029 | 0.049 |
| | 32 | — | 0.03 | — | — | 0.033 | 0.045 |
| | 33 | 0.17 | 0.02 | 0.27 | 0.006 | 0.030 | 0.053 |
| | 34 | — | 0.72 | — | 0.014 | 0.034 | 0.044 |

TABLE 3

| | | MANUFACTURING CONDITIONS OF COLD-ROLLED STEEL SHEET | | | | | |
|---|---|---|---|---|---|---|---|
| | | | | | | | COLD |
| | | | | HOT | | | ROLLING |
| | | SLAB | | ROLLING | | | COLD- |
| | | HEATING | | FINISHING | Ar₃ | COILING | ROLLING |
| | STEEL | TEMPERATURE | TIME | TEMPERATURE | POINT | TEMPERATURE | RATIO |
| | No. | (° C.) | (%) | (° C.) | (° C.) | (° C.) | (%) |
| INVENTION | 1 | 1200 | 3 | 896 | 749 | 625 | 69.4 |
| EXAMPLE | 2 | 1150 | 2 | 880 | 801 | 600 | 89.4 |
| | 3 | 1230 | 4 | 908 | 797 | 624 | 69.4 |
| | 4 | 1100 | 5 | 836 | 701 | 615 | 69.4 |
| | 5 | 1245 | 1 | 889 | 737 | 598 | 69.4 |
| | 6 | 1150 | 4 | 910 | 850 | 634 | 69.4 |
| | 7 | 1200 | 3 | 902 | 837 | 658 | 69.4 |
| | 8 | 1100 | 2 | 868 | 758 | 650 | 69.4 |
| | 9 | 1245 | 5 | 888 | 830 | 672 | 69.4 |
| | 10 | 1200 | 3 | 892 | 778 | 611 | 69.4 |
| | 11 | 1050 | 4 | 909 | 925 | 735 | 69.4 |
| | 12 | 1230 | 1 | 867 | 814 | 603 | 69.4 |
| | 13 | 1230 | 2 | 894 | 804 | 692 | 69.4 |
| | 14 | 1150 | 3 | 863 | 726 | 616 | 69.4 |
| | 15 | 1245 | 4 | 824 | 689 | 649 | 69.4 |
| | 16 | 1150 | 2 | 867 | 785 | 622 | 69.4 |
| | 17 | 1100 | 5 | 900 | 830 | 750 | 69.4 |
| | 18 | 1200 | 3 | 879 | 774 | 672 | 69.4 |
| | 19 | 1050 | 3 | 873 | 838 | 578 | 69.4 |
| | 20 | 1220 | 2 | 905 | 760 | 666 | 69.4 |
| COMPARATIVE | 21 | 1100 | 1 | 890 | 731 | 625 | 69.4 |
| EXAMPLE | 22 | 1245 | 4 | 900 | 731 | 638 | 69.4 |
| | 23 | 1220 | 5 | 808 | 640 | 572 | 69.4 |
| | 24 | 1150 | 3 | 995 | 870 | 599 | 69.4 |
| | 25 | 1200 | 2 | 857 | 790 | 621 | 69.4 |
| | 26 | 1230 | 3 | 879 | 836 | 638 | 69.4 |
| | 27 | 1100 | 4 | 909 | 790 | 689 | 69.4 |
| | 28 | 1050 | 3 | 893 | 759 | 841 | 69.4 |
| | 29 | 1200 | 3 | 902 | 744 | 635 | 69.4 |
| | 30 | 1100 | 2 | 897 | 827 | 600 | 69.4 |
| | 31 | 1150 | 1 | 890 | 783 | 599 | 69.4 |
| | 32 | 1230 | 4 | 888 | 839 | 615 | 69.4 |
| | 33 | 1200 | 5 | 904 | 801 | 750 | 69.4 |
| | 34 | 1220 | 3 | 910 | 791 | 657 | 69.4 |

| | | MANUFACTURING CONDITIONS OF | | | |
|---|---|---|---|---|---|
| | | COLD-ROLLED STEEL SHEET | | | |
| | | ANNEALING | | | |
| | | TEMPERATURE | | CONDITIONS OF HOT-DIPPING | |
| | | (° C.) | | | PLATING |
| | | ANNEALING | RECRYSTALLIZATION | | DEPOSITION |
| | STEEL | TEMPERATURE | TEMPERATURE | PLATING | AMOUNT |
| | No. | (° C.) | (° C.) | COMPOSITION | (PER ONE SIDE) |
| INVENTION | 1 | 805 | 696 | Sn-6_{MASS}% Zn | 30 g/m² |
| EXAMPLE | 2 | 798 | 761 | Sn-7_{MASS}% Zn | 30 g/m² |
| | 3 | 774 | 712 | Sn-8_{MASS}% Zn | 30 g/m² |
| | 4 | 770 | 686 | Sn-4_{MASS}% Zn | 50 g/m² |
| | 5 | 785 | 738 | Sn-5_{MASS}% Zn | 40 g/m² |
| | 6 | 830 | 772 | Sn-8_{MASS}% Zn | 50 g/m² |
| | 7 | 815 | 706 | Sn-3_{MASS}% Zn | 30 g/m² |
| | 8 | 802 | 726 | Sn-7_{MASS}% Zn | 70 g/m² |
| | 9 | 778 | 701 | Sn-6_{MASS}% Zn | 65 g/m² |
| | 10 | 793 | 732 | Sn-4_{MASS}% Zn | 70 g/m² |
| | 11 | 824 | 722 | Sn-5_{MASS}% Zn | 80 g/m² |
| | 12 | 813 | 676 | Sn-2_{MASS}% Zn | 60 g/m² |
| | 13 | 792 | 742 | Sn-3_{MASS}% Zn | 30 g/m² |
| | 14 | 805 | 792 | Sn-7_{MASS}% Zn | 120 g/m² |
| | 15 | 800 | 686 | Sn-7_{MASS}% Zn | 12 g/m² |
| | 16 | 813 | 687 | Sn-2_{MASS}% Zn | 150 g/m² |
| | 17 | 783 | 762 | Sn-1.1_{MASS}% Zn | 80 g/m² |
| | 18 | 830 | 681 | Sn-7_{MASS}% Zn | 130 g/m² |
| | 19 | 778 | 741 | Sn-7_{MASS}% Zn | 30 g/m² |
| | 20 | 770 | 691 | Sn-8.8_{MASS}% Zn | 30 g/m² |
| COMPARATIVE | 21 | 804 | 746 | Sn-6_{MASS}% Zn | 50 g/m² |
| EXAMPLE | 22 | 829 | 776 | Sn-7_{MASS}% Zn | 30 g/m² |
| | 23 | 778 | 701 | Sn-8_{MASS}% Zn | 40 g/m² |
| | 24 | 792 | 681 | Sn-6_{MASS}% Zn | 40 g/m² |
| | 25 | 808 | 762 | Sn-7_{MASS}% Zn | 65 g/m² |
| | 26 | 826 | 787 | Sn-7_{MASS}% Zn | 23 g/m² |
| | 27 | 799 | 730 | Zn | 47 g/m² |
| | 28 | 770 | 661 | Sn-04_{MASS}% Zn | 38 g/m² |
| | 29 | 830 | 815 | Sn-16_{MASS}% Zn | 30 g/m² |
| | 30 | 795 | 706 | Sn-7_{MASS}% Zn | 230 g/m² |
| | 31 | 823 | 747 | Sn-7_{MASS}% Zn | 4 g/m² |
| | 32 | 773 | 726 | Sn-7_{MASS}% Zn | 30 g/m² |
| | 33 | 811 | 766 | Sn-7_{MASS}% Zn | 40 g/m² |
| | 34 | 800 | 722 | Sn-7_{MASS}% Zn | 30 g/m² |

The above-described hot-rolled steel sheets were pickled, and then subjected to cold rolling at cold-rolling ratios presented in Table 3, to thereby produce cold-rolled steel sheets each having a thickness of 1.1 mm. The cold-rolled sheets were subjected to annealing at annealing temperatures presented in Table 3 for 60 seconds. The annealed steel sheets were subjected to electrolytic degreasing in a solution of NaOH of 40 g/L at 75° C., electrolytic pickling was then performed in a solution of H₂SO₄ of 120 g/L at 30° C., next, Fe—Ni plating was performed with a deposition amount of 1 g/m² per one side, and then Sn—Zn plating was performed using a flux method.

As the Fe—Ni alloy plating bath, a Watts bath of Ni plating to which 100 g/L of iron sulfate was added, was used. As a flux, an aqueous solution of ZnCl₂—NH₄Cl was applied to surfaces of the steel sheets by a roll.

Table 3 presents compositions of Sn—Zn plating baths. A bath temperature was set to 280° C., and after the plating, plating deposition amounts (per one side) were adjusted by gas wiping. Table 3 also presents the plating deposition amounts (per one side).

The steel sheets after being subjected to the hot-dipping were subjected to treatment in which Cr³⁺ was mainly used, to thereby produce hot-dip Sn—Zn plated steel sheets to be the invention examples and the comparative examples. Hot-dip Zn plating was performed on a part of the steel sheets in the middle of cooling after the above-described annealing.

Regarding the hot-dip plated steel sheets of the invention examples and the comparative examples, the tensile properties, the r value being an index of deep drawing, the secondary work brittleness resistance, the low-temperature toughness of coach peel seam weld zone and the corrosion resistance were evaluated. Methods of evaluation are as follows.

Regarding the tensile properties, a tensile test was conducted by collecting a JIS No. 5 test piece, from each of the hot-dip plated steel sheets, so that a tensile direction became parallel to a rolling direction, and the tensile strength (TS), the yield strength (YP), and elongation (El) were evaluated. The steel sheet with the elongation (El) of 28% or more was judged as passed.

The r value was measured by collecting JIS No. 5 tensile test pieces from each of the hot-dip plated steel sheets in three directions of a direction parallel to the rolling direction, a direction inclined by 45° from the rolling direction, and a direction orthogonal to the rolling direction. The evaluation was conducted based on an average value r ave of r values determined by the following expression <C>, in which an r value parallel to the rolling direction was set to r₀, an r value in the 45° direction was set to r₄₅, and an r value in the orthogonal direction was set to r₉₀. The steel sheet whose r ave was 1.10 or more was judged as passed.

r ave=(r₀+2×r₄₅+r₉₀)/4 <C>

The secondary work brittleness resistance was evaluated in a manner that a drawn cup manufactured by collecting a blank material with a diameter of 95 mm from each of the hot-dip plated steel sheets, and performing a cylindrical drawing using a punch with an outside diameter of 50 mm, was placed upside down on a truncated cone with a base angle of 30°, a weight having a weight of 5 kg was dropped from a position of a height of 1 m under various temperature conditions, as shown in FIG. 9, and the lowest temperature at which no crack occurred on the drawn cup (secondary work brittleness resistance temperature) was determined.

Although the secondary work brittleness resistance temperature changes depending on a sheet thickness of steel sheet and a methodx of test, in the present examples in which the sheet thickness of each of the cold-rolled steel sheets was 1.1 mm, the temperature of −50° C. or less was judged as passed.

The toughness of the coach peel seam weld zone was evaluated in a manner that a test piece shown in FIG. 6 was produced, horizontal parts of hot-dip plated steel sheets 1a, 1b were fixed by a chuck, a tensile force was applied at a rate of 200 mm/min under various temperatures, a fracture surface after the occurrence of fracture was examined, and a temperature at which a percentage of brittle fracture surface and that of ductile fracture surface became 50% and 50%, was determined as a ductile-brittle transition temperature (° C.). The steel sheet in which the temperature became −40° C. or less was judged as passed.

The corrosion resistance was evaluated by conducting a salt spray test (SST) being a test under a severe environment compared to an actual environment of fuel tank based on JIS Z 2371. The steel sheet in which the red rust generation ratio after 1000 hours was 10% or less was judged as passed.

Results of the above-described evaluation are presented in Table 4.

TABLE 4

| | | | | | | SECONDARY | DUCTILE-BRITTLE | |
|---|---|---|---|---|---|---|---|---|
| | | TENSILE PROPERTIES | | | | WORK | TRANSITION | |
| | | YIELD | TENSILE | | | BRITTLENESS | TEMPERATURE | SET RET RUST |
| | | STRENGTH | STRENGTH | ELONGATION | | RESISTANCE | OF COACH PEEL | GENERATION |
| | STEEL | YP | TS | El | | TEMPERATURE | SEAM WELD ZONE | RATIO |
| | No. | (MPa) | (MPa) | (%) | f_{AVG} | (° C.) | (° C.) | (%) |
| INVENTION | 1 | 301 | 461 | | 1.35 | −50 | −50 | 8 |
| EXAMPLE | 2 | 237 | 397 | 40.3 | 1.77 | −70 | −60 | 2 |
| | 3 | 263 | 423 | 36.9 | 1.60 | −60 | −70 | 9 |
| | 4 | 323 | 483 | 29.0 | 1.20 | −50 | −40 | 8 |
| | 5 | 308 | 468 | 30.9 | 1.30 | −50 | −40 | 4 |
| | 6 | 202 | 362 | 43.2 | 1.98 | −80 | −60 | 0 |
| | 7 | 206 | 366 | 42.4 | 1.91 | −80 | −60 | 5 |
| | 8 | 265 | 425 | 36.7 | 1.59 | −60 | −60 | 3 |
| | 9 | 224 | 384 | 42.1 | 1.86 | −80 | −60 | 4 |
| | 10 | 255 | 415 | 38.0 | 1.65 | −60 | −60 | 6 |
| | 11 | 231 | 391 | 41.2 | 1.81 | −70 | −60 | 5 |
| | 12 | 227 | 387 | 41.7 | 1.84 | −60 | −70 | 1 |
| | 13 | 221 | 381 | 42.5 | 1.88 | −70 | −70 | 6 |
| | 14 | 340 | 500 | 28.1 | 1.13 | −50 | −40 | 5 |
| | 15 | 348 | 508 | 28.3 | 1.11 | −50 | −50 | 8 |
| | 16 | 240 | 400 | 40.0 | 1.76 | −70 | −70 | 7 |
| | 17 | 248 | 408 | 38.9 | 1.70 | −60 | −60 | 9 |
| | 18 | 265 | 425 | 35.6 | 1.58 | −60 | −50 | 8 |
| | 19 | 229 | 389 | 41.5 | 1.83 | −70 | −70 | 7 |
| | 20 | 326 | 486 | 29.6 | 1.18 | −50 | −50 | 10 |
| COMPARATIVE | 21 | 305 | 465 | 24.3 | 1.05 | −50 | −30 | 8 |
| EXAMPLE | 22 | 317 | 477 | 29.7 | 1.24 | −60 | −50 | 91 |
| | 23 | 381 | 521 | 23.4 | 0.97 | −50 | −30 | 34 |
| | 24 | 264 | 424 | 35.8 | 1.59 | −10 | −10 | 10 |
| | 25 | 234 | 394 | 26.8 | 1.02 | −80 | −40 | 6 |
| | 26 | 214 | 374 | 27.4 | 1.09 | −60 | −10 | 3 |
| | 27 | 255 | 415 | 25.1 | 1.08 | −60 | −60 | 100 |
| | 28 | 283 | 443 | 34.3 | 1.47 | −20 | −60 | 28 |
| | 29 | 278 | 438 | 27.8 | 1.09 | −50 | −10 | 43 |
| | 30 | 244 | 404 | 39.5 | 1.73 | −30 | −30 | 3 |
| | 31 | 300 | 460 | 31.9 | 1.35 | −30 | −20 | 56 |
| | 32 | 227 | 387 | 26.2 | 1.07 | −50 | −30 | 8 |
| | 33 | 320 | 487 | 27.8 | 1.09 | −40 | −20 | 7 |
| | 34 | 354 | 512 | 25.3 | 1.03 | −30 | −10 | 4 |

As shown in Table 4, in the hot-dip plated steel sheet of the invention example No. 1, good corrosion resistance was provided, excellent workability was provided since the elongation (El) was 31.9% and the r ave was 1.35, and both of the secondary work brittleness resistance temperature and the ductile-brittle transition temperature of the coach peel seam weld zone were good since they were low temperatures.

Also in the hot-dip plated steel sheet of the invention example No. 2, excellent workability was provided since the elongation (El) was 40.3%, and the r ave was 1.77, and the corrosion resistance, the secondary work brittleness resistance and the toughness of the coach peel seam weld zone were also excellent.

Also in the hot-dip plated steel sheet of the invention example No. 3, excellent workability was provided since the elongation (El) was 36.9%, and the r ave was 1.60, and the corrosion resistance, the secondary work brittleness resistance and the toughness of the coach peel seam weld zone were also excellent.

In the hot-dip plated steel sheet of the invention example No. 4, good corrosion resistance was provided, excellent workability was provided since the elongation (El) was 29.0% and the r ave was 1.20, and both of the secondary work brittleness resistance temperature and the ductile-brittle transition temperature of the coach peel seam weld zone were good since they were low temperatures.

Also in the hot-dip plated steel sheet of the invention example No. 5, excellent workability was provided since the elongation (El) was 30.9%, and the r ave was 1.30, and the corrosion resistance, the secondary work brittleness resistance and the toughness of the coach peel seam weld zone were also excellent.

Also in the hot-dip plated steel sheet of the invention example No. 6, excellent workability was provided since the elongation (El) was 43.2%, and the r ave was 1.98, and the corrosion resistance, the secondary work brittleness resistance and the toughness of the coach peel seam weld zone were also excellent.

Also in the hot-dip plated steel sheet of the invention example No. 7, excellent workability was provided since the elongation (El) was 42.4%, and the r ave was 1.91, and the corrosion resistance, the secondary work brittleness resistance and the toughness of the coach peel seam weld zone were also excellent.

Also in the hot-dip plated steel sheet of the invention example No. 8, excellent workability was provided since the elongation (El) was 36.7%, and the r ave was 1.59, and the platability, the secondary work brittleness resistance and the toughness of the coach peel seam weld zone were also excellent. In like manner, each of the hot-dip plated steel sheets of the invention examples No. 9 to No. 20, also had excellent workability, corrosion resistance, secondary work brittleness resistance and toughness of the coach peel seam weld zone.

On the other hand, in the hot-dip plated steel sheet of the comparative example No. 21 in which the content of C was out of the range of the present invention, the elongation (El) and the r ave were low to be 24.3% and 1.05, respectively, and thus the workability was inferior to that of the hot-dip plated steel sheets of the invention examples, and further, the toughness of the coach peel seam weld zone was also inferior.

In the hot-dip plated steel sheet of the comparative example No. 22 in which the content of Si was out of the range of the present invention, the SST red rust generation ratio exceeded 90%, and the corrosion resistance was low. In the hot-dip plated steel sheet of the comparative example No. 23 in which the content of Mn exceeded the upper limit of the range of the present invention, the elongation (El) and the r ave were lower than those of the hot-dip plated steel sheets of the invention examples, resulting in that the workability was inferior, and further, the platability and the toughness of the coach peel seam weld zone were also inferior.

In the hot-dip plated steel sheet of the comparative example No. 24 in which the content of P was out of the range of the present invention, the secondary work brittleness resistance and the toughness of the coach peel seam weld zone were inferior to those of the hot-dip plated steel sheets of the invention examples. In the hot-dip plated steel sheet of the comparative example No. 25 in which the content of Ti was less than the range of the present invention, the elongation (El) and the r ave were low, resulting in that the workability was inferior.

In the hot-dip plated steel sheet of the comparative example No. 26 in which the content of Ti exceeded the range of the present invention, and the TB* was lower than the range of the present invention, the elongation (El) and the r ave were low, and further, the toughness of the coach peel seam weld zone was also inferior to that of the hot-dip plated steel sheets of the invention examples.

In the hot-dip plated steel sheet of the comparative example No. 27 in which the content of Nb was less than the range of the present invention, the elongation (El) and the r ave were low, and thus it did not meet the object of the present invention. Further, since the hot-dip plated layer was the hot-dip Zn plated layer, the corrosion resistance was inferior to that of the hot-dip plated steel sheets of the invention examples.

In the hot-dip plated steel sheet of the comparative example No. 28 in which the content of B was less than the range of the present invention, the secondary work brittleness resistance temperature was −20° C., which was inferior, compared to the hot-dip plated steel sheets of the invention examples. Further, since the Zn amount in the hot-dip plated layer was low, a sufficient sacrificial corrosion prevention effect was not exhibited, and the corrosion resistance was inferior.

In the hot-dip plated steel sheet of the comparative example No. 29 in which the content of B exceeded the range of the present invention, the elongation (El) and the r ave were low, and further, the ductile-brittle transition temperature of the coach peel seam weld zone was high, and the toughness of the weld zone was inferior. Further, the Zn amount in the hot-dip plated layer was large, the Sn primary crystal did not appear, and the Zn segregation in eutectic cell grain boundary and the growth of coarse Zn crystal were facilitated, resulting in that the corrosion resistance was lowered.

In each of the hot-dip plated steel sheets of the comparative examples No. 30 and No. 31 in which the value of [P] exceeded 10×[B13]+0.03, the secondary work brittleness resistance temperature was −30° C., which was inferior, compared to the hot-dip plated steel sheets of the invention examples, and further, the toughness of the coach peel seam weld zone was also low.

Further, in the hot-dip plated steel sheet of the comparative example No. 31, the plating deposition amount was small and the corrosion resistance was inferior, and in the hot-dip plated steel sheet of the comparative example No. 30, the plating deposition amount was large, resulting in that a surface of plating exhibited a pattern-shaped appearance to deteriorate a surface property, and the weldability was lowered.

In the hot-dip plated steel sheet of the comparative example No. 32 in which the content of Al was less than the range of the present invention, an oxide was generated in the steel due to the insufficient deoxidation, resulting in that the workability was inferior since the elongation (El) and the r ave were low, the ductile-brittle transition temperature of the coach peel seam weld zone was high, and the toughness of the weld zone was inferior.

In each of the hot-dip plated steel sheets of the comparative examples No. 33 and No. 34 in which the content of Al exceeded the range of the present invention, the toughness of the coach peel seam weld zone and the secondary work brittleness resistance were inferior to those of the hot-dip plated steel sheets of the invention examples, and the workability was inferior since the elongation (El) and the r ave were low.

### INDUSTRIAL APPLICABILITY

As described above, according to the present invention, it is possible to provide a hot-dip plated high-strength steel sheet for presswork having a tensile strength of 340 MPa or more and less than 540 MPa, a press formability capable of being applied to a field of automobile, particularly a fuel tank, excellent secondary work brittleness resistance and toughness of a coach peel weld zone at low temperature, and excellent corrosion resistance.

Further, the fuel tank manufactured by using the hot-dip plated high-strength steel sheet for presswork of the present invention exhibits an excellent effect with respect to a biofuel. Therefore, the present invention has a high industrial applicability.

### EXPLANATION OF CODES

1a, 1b hot-dip plated steel sheet
2 weld zone (coach peel seam weld zone)
3 drawn cup
4 truncated cone
5 weight

1. A hot-dip plated high-strength steel sheet for presswork excellent in low-temperature toughness and corrosion resistance, comprising
a high-strength steel sheet having a hot-dip plated layer on a surface of a cold-rolled steel sheet, wherein:
the cold-rolled steel sheet contains:
by mass %,
C: 0.0005 to 0.0050%;
Si: 0.30% or less;
Mn: 0.70 to 3.00%;
P: 0.05% or less;
Ti: 0.01 to 0.05%;
Nb: 0.01 to 0.04%;
B: 0.0005 to 0.0030%;
S: 0.01% or less;
Al: 0.01 to 0.30%;
N: 0.0005 to 0.010%; and
a balance composed of Fe and inevitable impurities;
when the Ti content (%) is set to [Ti], the B content (%) is set to [B], and the P content (%) is set to [P], TB* defined by the following expression <A> is 0.03 to 0.06, and [B] and [P] satisfy the following expression <B>:
TB*=(0.11−[Ti])/(ln([B]×10000)) <A>
[P]≦10×[B]+0.03 <B>

2. The hot-dip plated high-strength steel sheet for presswork excellent in low-temperature toughness and corrosion resistance according to claim 1, wherein
the cold-rolled steel sheet further contains, by mass %,
one or two or more of
Cu: 0.005 to 1%,
Ni: 0.005 to 1%,
Cr: 0.005 to 1%, and
Mo: 0.0005 to 1%.

3. The hot-dip plated high-strength steel sheet for presswork excellent in low-temperature toughness and corrosion resistance according to claim 1, wherein
the hot-dip plated layer is made of Zn of 1.0 to 8.8 mass %, and a balance composed of Sn and inevitable impurities, and a plating deposition amount is 10 to 150 g/m² per one side.

4. The hot-dip plated high-strength steel sheet for presswork excellent in low-temperature toughness and corrosion resistance according to claim 1, wherein
a secondary work brittleness resistance temperature after performing working on the high-strength steel sheet at a drawing ratio of 1.9 is −50° C. or less.

5. The hot-dip plated high-strength steel sheet for presswork excellent in low-temperature toughness and corrosion resistance according to claim 1, wherein
a ductile-brittle transition temperature of a coach peel seam weld zone of the high-strength steel sheet is −40° C. or less.

6. A manufacturing method of a hot-dip plated high-strength steel sheet for presswork excellent in low-temperature toughness and corrosion resistance comprising:
a step of obtaining a slab by making a molten steel having a chemical composition same as a chemical composition of the cold-rolled steel sheet according to claim 1 to be subjected to continuous casting;
a step of obtaining a hot-rolled coil by heating the slab at 1050 to 1245° C. for a period of time within 5 hours, completing, after the heating, hot rolling at a finishing temperature of Ar₃ to 910° C. to produce a hot-rolled steel sheet, and then coiling the hot-rolled steel sheet at a temperature of 750° C. or less;
a step of performing cold rolling on the hot-rolled steel sheet at a cold-rolling ratio of 50% or more to produce a cold-rolled steel sheet, and then obtaining a cold-rolled coil; and
a step of performing annealing on the cold-rolled steel sheet at a temperature of recrystallization temperature or more, and then performing hot-dipping.

7. The manufacturing method of the hot-dip plated high-strength steel sheet for presswork excellent in low-temperature toughness and corrosion resistance according to claim 6, wherein
hot-dipping containing Zn of 1.0 to 8.8 mass % and a balance composed of Sn and inevitable impurities, and whose plating deposition amount is 10 to 150 g/m² per one side is performed in the step of performing the hot-dipping.

8. The manufacturing method of the hot-dip plated high-strength steel sheet for presswork excellent in low-temperature toughness and corrosion resistance according to claim 6, wherein
pre-plating of Fe—Ni is performed before performing the hot-dipping in the step of performing the hot-dipping.
